(19) United States
(12) Patent Application Publication
(10) Pub. No.: US 2010/0224400 A1
(43) Pub. Date: Sep. 9, 2010

(54) OVERLAP HELICAL CONDUCTIVE SPRING

(75) Inventors: Jon M. Lenhert, Brea, CA (US); Karthik Vaideeswaran, Redondo Beach, CA (US); Donald M. Munro, Long Beach, CA (US)

Correspondence Address: LARSON NEWMAN & ABEL, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 12/719,377

(22) Filed: Mar. 8, 2010

Related U.S. Application Data
(60) Provisional application No. 61/158,205, filed on Mar. 6, 2009.

(51) Int. Cl. H01R 4/00; F16F 1/06

(52) U.S. Cl. 174/366; 267/166; 267/167

(57) ABSTRACT

A cross-diametric compression spring includes a conductive ribbon formed into an overlapping helical coil wherein adjacent loops of the conductive ribbon overlap. The conductive ribbon has a width extending substantially parallel to length of the overlapping helical coil.

### CROSS-REFERENCE TO RELATED APPLICATION(S)

The present application claims priority from U.S. Provisional Patent Application No. 61/158,205, filed Mar. 6, 2009, entitled “OVERLAP HELICAL CONDUCTIVE SPRING,” naming inventors Jon M. Lenhert, Karthik Vaideeswaran and Donald M. Munro, which application is incorporated by reference herein in its entirety.

### FIELD OF THE DISCLOSURE

The present disclosure relates generally to electromagnetic interference/radio frequency interference (EMI/RFI) gaskets. More specifically, the present disclosure relates to an overlap helical conductive springs.

### BACKGROUND

Electronic noise (EMI) and radio frequency interference (RFI) are the presence of undesirable electromagnetic energy in an electronic system. EMI can result from unintentional electromagnetic energy generate in and around the electronic system. For example, electrical wiring can generate electronic noise at about 60 Hz. Other sources of unintentional electromagnetic energy can include thermal noise, lightning, and static discharges. Additionally, EMI can result from intentional electromagnetic energy, such as radio signals used for radio and television broadcasts, wireless communication systems such as cellular phones, and wireless computer networks.

Elimination of EMI is important in the design of electronic systems. Placement of components within the system, as well as the use of shielding and filtering, make it possible to control and reduce the EMI that interferes with the function of the electronic system as well as the EMI produced by the electronic system that can interfere with other systems. The effectiveness of shielding and filtering is dependent on the methods by which the shielding materials are bonded together. Electrical discontinuities in the enclose, such as joints, seems, and gaps, all effect the frequency and the amount of EMI that can breach the shielding.

### SUMMARY

In an embodiment, a cross-diametric compression spring includes a conductive ribbon formed into an overlapping helical coil. The width of the conductive ribbon extends substantially parallel to the length of the overlapping helical coil. The thickness of the conductive ribbon is smaller than the width. Adjacent loops of the conductive ribbon overlap along the width of the conductive ribbon.

### BRIEF DESCRIPTION OF THE DRAWINGS

The present disclosure may be better understood, and its numerous features and advantages made apparent to those skilled in the art by referencing the accompanying drawings.

FIG. 1 is a diagram illustrating an overlapping helical coil.

FIG. 2 is a diagram illustrating a circular cross section of the coil.

FIG. 3 is a diagram illustrating an overlapping helical coil formed in a torus.

FIG. 4 is a graph showing the attenuation of an overlapping helical coil as a function of frequency.

FIG. 5 is a graph showing the attenuation of a non-overlapping helical coil as a function of frequency.

The use of the same reference symbols in different drawings indicates similar or identical items.

### DETAILED DESCRIPTION

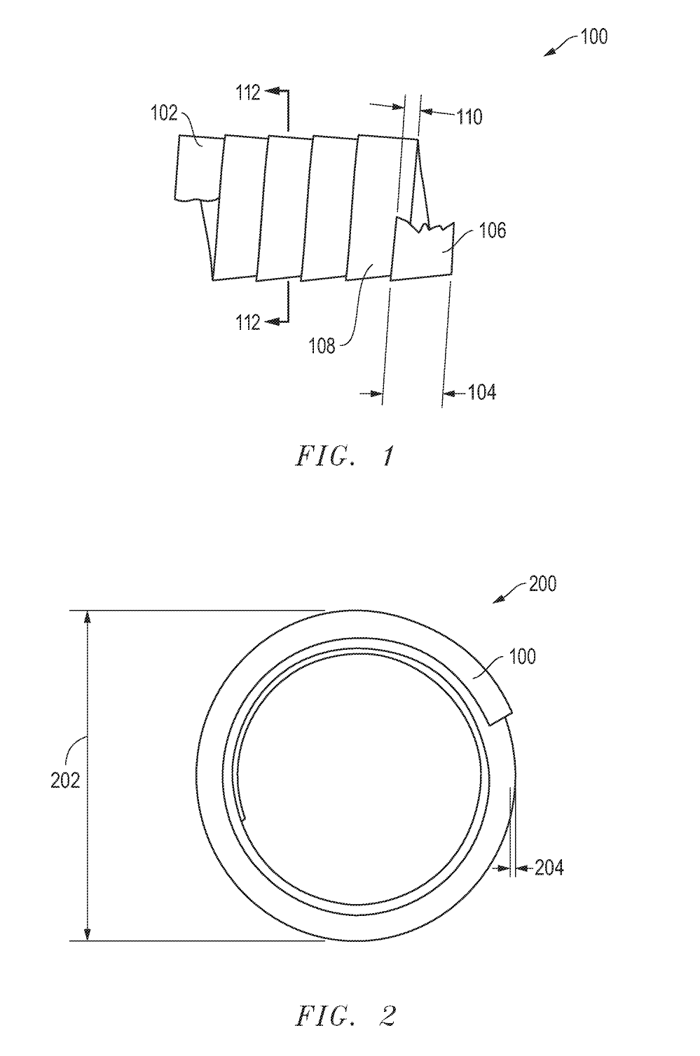

FIG. 1 illustrates an overlapping helical coil, generally designated 100. The overlapping helical coil 100 includes a ribbon 102 having a width 104. In an embodiment, the width can be between about 0.060 inches and about 0.300 inches. The ribbon can be formed into an overlapping helical coil such that loop 106 of the helical coil 100 overlaps with preceding loop 108 by an overlap distance 110. In an embodiment, the overlap distance 110 can be between about 20% and about 40% of the width 104.

In an embodiment, ribbon 102 can be a conductive ribbon. The conductive ribbon can be formed from a metal or a metal alloy. The metal alloy can be a stainless steel, a copper alloy such as beryllium copper and copper-chromium-zinc alloy, a nickel alloy such as hastelloy, Ni220, and Phynox, or the like. Additionally, the conductive ribbon can be plated with a plating metal, such as gold, tin, nickel, silver or any combination thereof. In an alternative embodiment, the conductive ribbon can be formed of a polymer coated with a plating metal.

FIG. 2 illustrates a circular cross section 200 of the overlapping helical coil 100 taken along line 112. The circular cross section 200 of the overlapping helical coil 100 illustrates a coil diameter 202. Further, the circular cross section illustrated the ribbon thickness 204. In an embodiment, the coil diameter can be between about 0.060 inches and about 0.250 inches. Generally, the coil diameter 202 can be less than about three times the width of the conductive ribbon. The ribbon thickness 204 can be between about 0.003 inches and about 0.006 inches. In an embodiment, the overlapping helical coil 100 can be a cross-diametric spring, such that the spring resists compression across the diameter of the overlapping helical coil 100.

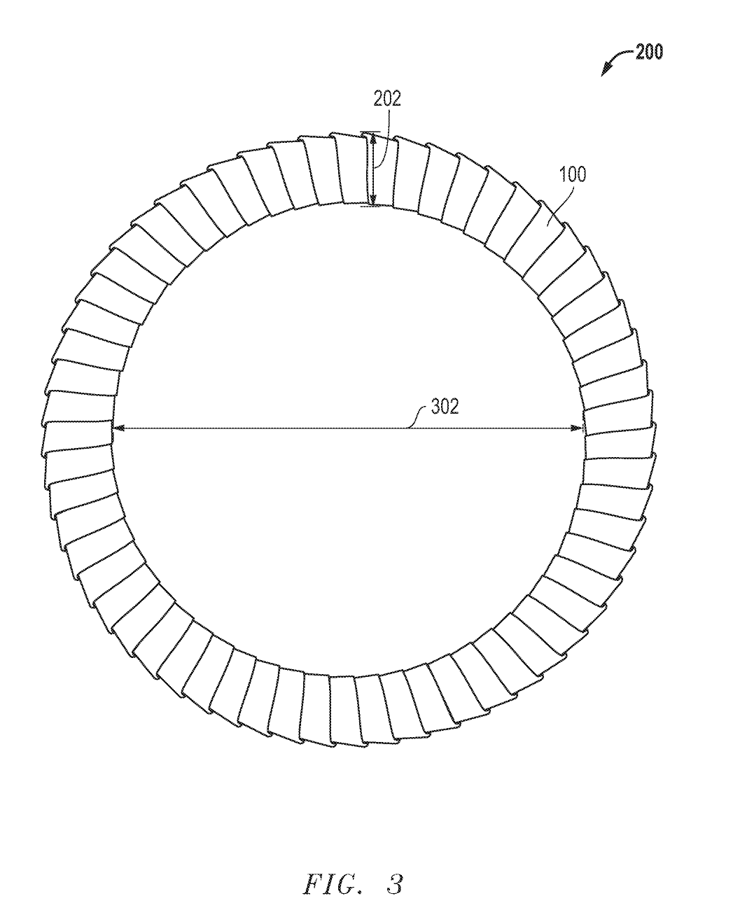

FIG. 3 illustrates an exemplary overlapping helical coil formed into a torus, generally designated 300. In an embodiment, the torus 300 can be formed by joining two ends of the conductive ribbon together, such as by welding. The overlapping helical coil can have an inner diameter 302. In an embodiment, he inner diameter can be at least not less than about 8 times a coil diameter of the overlapping helical coil 202.

In an alternative embodiment, there can be a gap between the ends of the coil. Generally, the gap should be small, such as not greater than about 5% of the diameter 302 of the torus 300, not greater than about 2.5% of the diameter 302 of the torus 300, even not greater than about 1% of the diameter 302 of the torus 300.

The cross diametric compression spring can be used as a gasket or seal in an electronic system to reduce EMI/RFI. In an embodiment, the cross diametric compression spring can be placed between two parts of an electronics enclosure, such as between a body and a lid, to provide an EMI/RFI seal. Preferably, the ends of the spring can be welded together to prevent the formation of a gap in the seal. Alternatively, the ends of the spring may not be welded, but can be placed close together to minimize the formation of a gap.

The cross diametric compression spring can significantly reduce the electromagnetic energy able to pass through the space between the two parts of the enclosure. For example, the cross diametric compression spring may attenuate the electromagnetic energy passing through the space by at least −70 dB, such as at least −80 dB. Additionally, the cross diametric compression spring can have a substantially constant attenuation over a range of frequencies, such as between about 1 MHz and about 600 MHz. In an embodiment, the cross-diametric compression spring can have an Attenuation Resistance Rating of not less than about 2.0 dB ohms per inch, such as not less than about 3.0 dB ohms per inch, even not less than about 3.5 dB ohms per inch. The Attenuation Resistance Rating is the product of the DC resistance and the shielding quality at 600 MHz.

### EXAMPLES

Samples were prepared using full hard 301 Stainless Steel having a bright surface. The compressive load is measured using a spring tester. The DC resistance is determined using an Agilent 4338B milliohmmeter. In accordance with SAE ARP1706 Rev A, the attenuation is determined using an Agilent E4402 and the attenuation is standardized to Shielding Quality. Attenuation Resistance Rating is determined by multiplying the DC resistance by the shielding quality at 600 MHz.

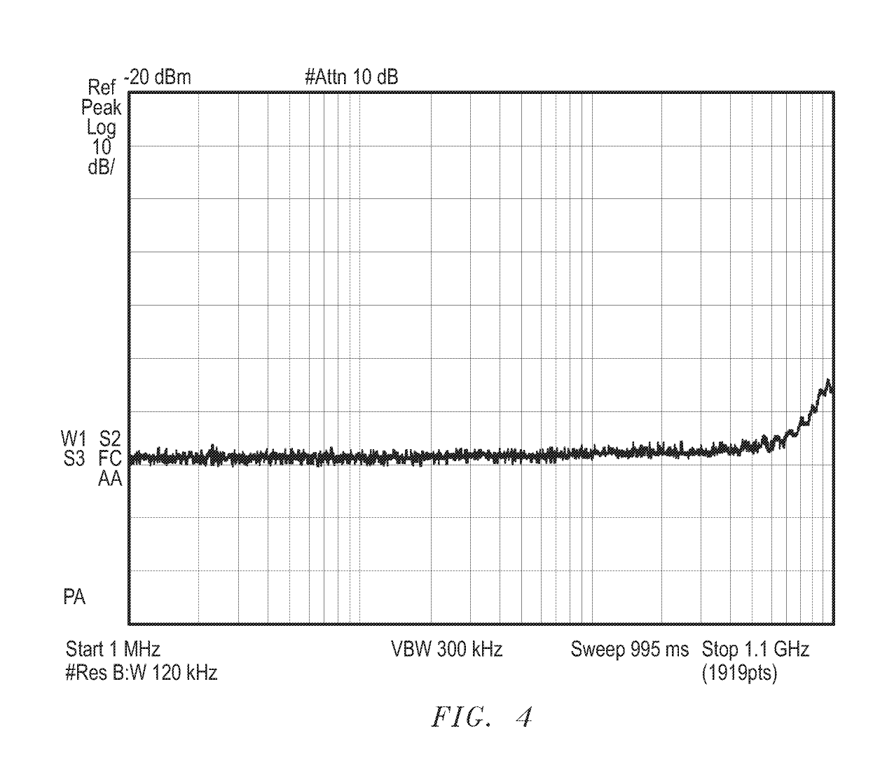

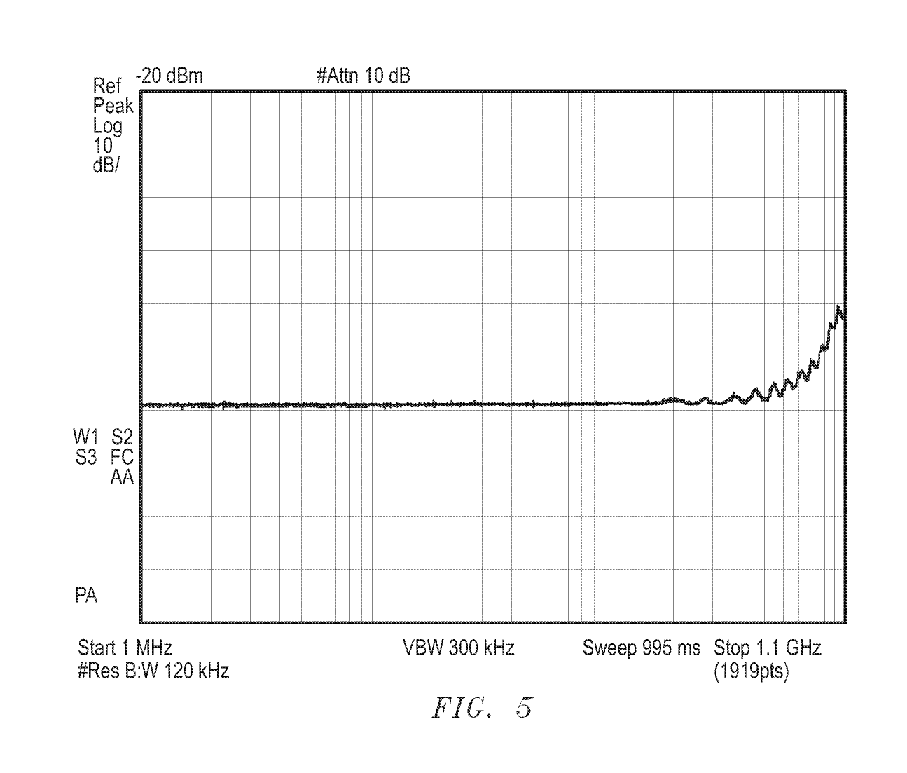

Sample 1 is an overlapping helical coil made from 0.002 inch thick and 0.125 inch wide ribbon formed in a helical coil having an 0.188 inch outer diameter and a 30% overlap between adjacent loops. The compressive load measured at 0.015-inch compression is 7.0 pound-feet per inch of length of the helical coil. DC resistance is determined to be 30.060 milliohm per inch. As shown in FIG. 4, sample 1 has an attenuation of −88 dB over the frequency range of 1 MHz to about 600 MHz with the attenuation diminished to about −75 dB over the range of 600 MHz to 1 GHz. Table 1 shows the Shielding Quality. The Attenuation Resistance Rating is about 3.5 dB ohms per inch.

Sample 2 is a non-overlapping helical coil made from 0.004 inch thick and 0.062 inch wide ribbon formed in a helical coil having a 0.188-inch outer diameter and a 0.005-inch gap between adjacent loops. The compressive load measured at 0.015-inch compression is 9.8 pound-feet per inch of length of the helical coil. DC resistance is determined to be 14.43 milliohm per inch. As shown in FIG. 4, sample 1 has an attenuation of −81 dB over the frequency range of 1 MHz to 400 MHz with the attenuation diminished to about −63 dB over the range of 400 MHz to 1 GHz. The Attenuation Resistance Rating is about 1.7 dB ohms per inch.

TABLE 1
Shielding Quality

| | Sample 1 | Sample 2 |
|---|---|---|
| 1 MHz | 121 dB | 117 dB |
| 10 MHz | 121 dB | 117 dB |
| 400 MHz | 121 dB | 117 dB |
| 600 MHz | 118 dB | 115 dB |
| 900 MHz | 113 dB | 108 dB |

1. A cross-diametric compression spring comprising:
a conductive ribbon formed into an overlapping helical coil wherein adjacent loops of the conductive ribbon overlap, the conductive ribbon having a width and the overlapping helical coil having a length, the width of the conductive ribbon extending substantially parallel to length of the overlapping helical coil.

2. The cross-diametric compression spring of claim 1, wherein the width of the conductive ribbon is between about 0.060 inches and about 0.300 inches.

3. The cross-diametric compression spring of claim 1, wherein the conductive ribbon has a thickness of between about 0.003 inches and about 0.006 inches.

4. The cross-diametric compression spring of claim 1, wherein the adjacent loops overlap by an overlap distance of between about 20% and about 40% of the width.

5. The cross-diametric compression spring of claim 1, wherein the helical coil has a coil diameter of less than about three times the width of the conductive ribbon.

6. The cross-diametric compression spring of claim 1, wherein the helical coil has a coil diameter of between about 0.060 inches and about 0.250 inches.

7. The cross-diametric compression spring of claim 1, wherein the conductive ribbon is formed of a metal or metal alloy.

8. The cross-diametric compression spring of claim 7, wherein the metal alloy includes a nickel alloy, a copper alloy, stainless steel, or any combination thereof.

9-10. (canceled)

11. The cross-diametric compression spring of claim 1, wherein the conductive ribbon is plated with a plating metal.

12. (canceled)

13. The cross-diametric compression spring of claim 1, wherein the overlapping helical coil is curved to form a torus.

14. The cross-diametric compression spring of claim 13, wherein the helical coil has a coil diameter and the torus has an inner diameter, the inner diameter being is not less than about 8 times the coil diameter.

15. The cross-diametric compression spring of claim 13, wherein opposing ends of the conductive ribbon are separated by a distance of less than 5% of the length of the overlapping helical coil.

16-17. (canceled)

18. The cross-diametric compression spring of claim 15, wherein opposing ends of the conductive ribbon are welded together.

19. A cross-diametric compression spring comprising
a conductive ribbon formed into an overlapping helical coil, the overlapping coil shaped to form a torus,
wherein the cross-diametric compression spring has an Attenuation Resistance Rating of not less than about 2.0 dB ohms per inch.

20. The cross-diametric compression spring of claim 19, wherein the Attenuation Resistance Rating of not less than about 3.0 dB ohms per inch.

21. The cross-diametric compression spring of claim 20, wherein the Attenuation Resistance Rating of not less than about 3.5 dB ohms per inch.

22. A electromagnetic interference seal comprising:
a cross-diametric compression spring including a conductive ribbon having a width and formed into an overlapping helical coil, wherein adjacent loops of the conductive ribbon overlap along the width by an overlap distance,
wherein the cross-diametric compression spring is configured to reduce electromagnetic interference when placed between two portions of an electronics enclosure.

23-24. (canceled)

25. The electromagnetic interference seal of claim 22, wherein the overlap distance is between about 20% and about 40% of the width.

26. The electromagnetic interference seal of claim 22, wherein the overlapping helical coil has a coil diameter of less than about three times the width of the conductive ribbon.

27. (canceled)

28. The electromagnetic interference seal of claim 22, wherein the conductive ribbon is formed of a metal or metal alloy.

29-31. (canceled)

32. The electromagnetic interference seal of claim 22, wherein the conductive ribbon is plated with a plating metal.

33. (canceled)

34. The electromagnetic interference seal of claim 22, wherein the overlapping helical coil is curved to form a torus.

35. The electromagnetic interference seal of claim 34, wherein an inner diameter of the torus is not less than about 8 times a coil diameter of the overlapping helical coil.

36-39. (canceled)
